(19) United States
(12) Patent Application Publication
(10) Pub. No.: US 2021/0325112 A1
(43) Pub. Date: Oct. 21, 2021

(54) BURNER LANCE INSERT FOR AN ELECTRIC ARC FURNACE

(71) Applicant: Primetals Technologies Germany GmbH, Erlangen (DE)

(72) Inventors: Hannes BEILE, Ettenheim (DE); Alexander MUELLER, Offenburg (DE); Anton ROESSLE, Blaubeuren (DE)

(21) Appl. No.: 16/479,734

(22) PCT Filed: Jan. 24, 2018
(86) PCT No.: PCT/EP2018/051703

§ 371 Date: Jul. 22, 2019

(30) Foreign Application Priority Data
Jan. 24, 2017 (EP) 17152834.2

(51) Int. Cl. F27B 3/20; F27B 3/22

(52) U.S. Cl. CPC F27B 3/205; F27B 3/225

(57) ABSTRACT

A burner lance insert (1) for an electric arc furnace (2), includes a support body (3) that can be inserted into a wall opening (17) of the electric arc furnace (2). The insert has a front opening (5), a burner lance unit (7) which is mounted in the support body (3) in a rotatable manner about a rotational axis (A). A discharge channel (28) runs to a burner lance unit (7) discharge opening (29) lying in the front opening (5). A drive unit (9) rotates the burner lance unit (7) between two end positions in which the discharge opening (29) assumes different positions in the front opening (5) and the discharge channel (28) defines different discharge directions. The rotational axis (A) forms an angle between 30 degrees and 60 degrees, particularly preferably 40 degrees to 0 degrees, together with the direction of the gravitational force of the Earth after the support body (3) is inserted into the wall opening (17). The burner lance unit (7) is suitable for carrying out a burner operation as well as a lancing operation.

### CROSS-REFERENCE TO RELATED APPLICATIONS

The present application is a 35 U.S.C. §§ 371 national phase conversion of PCT/EP2018/051703, filed Jan. 24, 2018, the contents of which are incorporated herein by reference, which claims priority of European Application No. 17152834.2, filed Jan. 24, 2017, the contents of which are incorporated by reference herein. The PCT International Application was published in the German language.

### FIELD OF THE INVENTION

The invention relates to a burner lance insert for an electric arc furnace.

### TECHNICAL BACKGROUND

In electric arc furnaces, auxiliary burners and/or thermal lances are frequently used in order to additionally introduce energy into regions of electric arc furnaces that are not heated sufficiently by the energy of the electric arcs.

The object of the invention is to provide an improved burner lance device for introducing energy into an electric arc furnace.

### PRIOR ART

A burner insert for an electric arc furnace is disclosed, for example, in DE102012007528 B3. The burner is so mounted that there is movement from the edge to the middle of the furnace crucible, that is, the axis of rotation is arranged in the horizontal direction. The rotational movement takes place solely in the vertical direction; no rotational movement is provided in the horizontal direction.

### SUMMARY OF THE INVENTION

A burner lance insert according to the invention for an electric arc furnace has a support body, a burner lance unit and a drive unit. The support body is configured to be inserted into a wall opening of the electric arc furnace. The support body and has a front opening which, after the support body has been inserted into the wall opening, faces the furnace interior of the electric arc furnace. The burner lance unit is mounted in the support body to be rotatable about an axis of rotation. The burner lance unit has a delivery channel which extends to a delivery opening of the burner lance unit located in the front opening. After the support body has been inserted into the wall opening, the axis of rotation forms an angle of between 30 degrees and 60 degrees, particularly preferably from 40 degrees to 50 degrees, with the direction of the force of gravity and there defines a delivery direction of the burner lance unit for the delivery of a fuel and/or a flame. The delivery direction is always directed into the furnace crucible after the support body has been inserted into the wall opening. The burner lance unit is suitable for performing both a burner operation and a lance operation. By means of the drive unit, the burner lance unit is rotatable between two end positions in which the delivery opening assumes positions in the front opening which are different from one another and the delivery channel defines delivery directions which are different from one another.

The furnace crucible is the part of an electric arc furnace which receives molten metal. The furnace crucible has a lining. The delivery direction should be so oriented that it can always be directed at the molten metal and, before molten metal is present, at the scrap metal which has been introduced. This means that, over the entire range from one end position into the second end position, the delivery direction is always directed into the furnace crucible. The delivery direction should not point towards a furnace wall or a furnace roof.

The profile of the axis of rotation forms an angle of between 30 degrees and 60 degrees with the direction of the force of gravity, wherein, after the support body has been inserted into the wall opening, a main movement component of the rotational movement of the burner lance unit points to the left or right, that is it is at a 90 degree angle to the direction of the force of gravity. After the support body has been inserted into the wall opening, the rotational movement of the burner lance unit thus takes place such that the main movement component takes place in the horizontal direction. In addition to the main movement component, movement components can of course also point in other directions, depending on how the axis of rotation A is arranged, but the predominant part of the movement of over 60%, preferably over 70%, particularly preferably over 80%, should take place in the horizontal direction, that is, at 90 degrees to the direction of the force of gravity. The forms known in the prior art, for example, DE102012007528 B3, have an axis of rotation which is always arranged parallel to the upper edge of the lining, or at a 90 degree angle to the direction of the force of gravity. With the support body inserted into the wall opening, the main movement component points in the direction of or contrary to the direction of the force of gravity or in the direction or contrary to the direction of electrodes of the electric arc furnace. In this form, the movement thus points upwards or downwards or inwards or outwards. After the support body has been inserted into the wall opening, the main movement component of the present invention should not point solely in the direction of or contrary to the direction of the force of gravity or in the direction of the electrodes, or towards the middle of the electric arc furnace.

The burner lance insert makes it possible that, in burner operation, scrap melting is more effective since, owing to the rotational movement to the left or right, the energy input to the scrap which has been introduced into the electric arc furnace is better. When the scrap has melted, the burner lance unit is switched to lance operation. In lance operation, an injection of oxygen can be distributed to a larger steel bath volume. Local overheating is thus avoided. The rotational movement as disclosed, for example, in DE102012007528 B3, in which the rotational movement takes place in such a manner that the delivery direction can be guided from the side to the middle of the electric arc furnace, causing a problem that the energy input in the direction of the electrodes is too high or that splashes hit the electrodes. As a result of the rotational movement of the burner lance unit, better homogenization of the steel bath volume is achieved, owing to the better energy distribution. The burner lance insert according to the invention causes a melting process and homogenization of the melt in the electric arc furnace to be more efficient and quicker.

By arranging the burner lance unit in the support body and arranging the delivery opening in the front opening of the support body, the burner lance insert is particularly compact and therefore can be integrated in a space-saving manner into a burner panel. The rotatable mounting of the burner lance unit in the support body further allows the delivery direction of the burner lance unit to be changed, so that the energy delivered by the burner lance unit can advantageously be distributed over a larger region in the electric arc furnace than would occur with a fixed arrangement of the burner lance unit, and so that the efficiency of the burner capacity, or of the fuel input, of the burner lance unit in the electric arc furnace are increased.

An advantageous embodiment provides that the drive unit has a drive cylinder which is arranged at least approximately parallel to the delivery channel and which is connected via a first link to the support body and via a second link to the burner lance unit.

Arrangement of the drive cylinder parallel to the delivery channel is understood as meaning that a drive piston of the drive cylinder moves approximately parallel to the delivery channel of the burner lance unit, when this delivery channel is in a middle position lying between the two end positions. Approximately parallel is understood as meaning a deviation of ±10 degrees. The arrangement of the working cylinder at least approximately parallel to the delivery channel advantageously effects a space-saving arrangement of the drive unit and further reduces the installation space required for the burner lance insert.

One embodiment of the invention provides that the burner lance unit has a delivery component on the front opening side, through which an end portion runs, on the front opening side, of the delivery channel and which has two convex outer surfaces located opposite one another on different sides of the delivery channel. The surface normals of the convex outer surfaces lie in planes perpendicular to the axis of rotation and each extend to the front opening. The ends on the front opening side of the two convex outer surfaces are connected, for example, by a planar surface region of the delivery component, in which the delivery opening is arranged.

The delivery component further has, for example, a cooling channel, a coolant inlet for the introduction of a coolant into the cooling channel, and a coolant outlet for discharging the coolant from the cooling channel. Furthermore, the drive unit is connected, for example, via the second link to the delivery component. The design of the delivery component with two convex outer surfaces advantageously makes possible a structurally simple and space-saving rotation of the delivery component in the region of the front opening. The planar design of the surface region of the delivery component surrounding the delivery opening advantageously effects a more compact form of the delivery component compared with a curved design. The design of the delivery component with a cooling channel, a coolant inlet and a coolant outlet advantageously allows the delivery component to be cooled by a coolant which is guided through the cooling channel. The connection of the drive unit to the delivery component via the second link advantageously effects a force input of the drive unit acting directly on the delivery component.

In a further embodiment of the invention, there is a seal for sealing a gap between the burner lance unit and the support body in the region of the front opening. Damage to the burner lance insert as a result of the penetration of harmful substances into the support body can thus advantageously be prevented.

In a further embodiment of the invention, the burner lance unit has a feed unit for introducing the fuel into the delivery channel. For example, the feed unit is releasably connected to the delivery component. The feed unit allows the burner lance unit to be supplied with fuels. The releasable connection of the feed unit and the delivery component simplifies maintenance and replacement of the burner lance unit.

In a further embodiment of the invention provides that the delivery channel runs perpendicular to the axis of rotation. The efficiency of the drive unit is thus advantageously increased, since rotations of the burner lance unit are optimally converted into changes in the delivery direction of the burner lance unit.

In a further embodiment of the invention, the delivery direction in a middle position of the burner lance unit lying between the two end positions forms an angle of between 30 degrees and 60 degrees, particularly preferably between 40 degrees and 50 degrees, with the direction of the force of gravity, when the burner lance insert is inserted into the wall opening of the electric arc furnace. In the middle position, an angle of the delivery direction to a front plate in which the delivery opening is arranged is 90 degrees. Rotation of the burner lance unit into one of the two end positions, changes this angle of the delivery direction to the front plate.

In a further embodiment of the invention, the support body comprises a front plate which has a front opening, a cover plate which is arranged above the front plate, and two side plates, wherein the side plates are each connected to the front plate and to the cover plate and enclose the front opening. The burner lance unit is mounted in the support body to be rotatable about the axis of rotation, wherein the axis of rotation is arranged so that the burner lance unit is movable predominantly, preferably exclusively, in the direction of one of the two side plates. The axis of rotation can be configured so that it is almost parallel to a front edge of the side plate, wherein the front edge is connected to the front plate. Front edge is understood as meaning the cut edge between the front plate and a side plate. The side plates are arranged almost at right angles to the upper edge of the lining. The front plate is oriented at an angle of between 30 and 60° to the upper edge of the lining. The axis of rotation is likewise at a fixed angle to the upper edge of the lining, which is between 30 and 60°. Movable in the direction of the side plates is to be understood as meaning that a main movement component points in the direction of one of the side walls.

In a further embodiment of the invention, rotation of the burner lance unit from a first end position into the second end position changes the delivery direction by up to 60 degrees, preferably by from 20 to 30 degrees. These angle ranges advantageously allow particularly efficient distribution of the energy of the burner lance unit in the electric arc furnace.

In a further embodiment of the invention, the drive cylinder is a hydraulic or pneumatic cylinder. This advantageously allows a structurally simple and flexible form of the drive unit with high degrees of efficiency and positioning accuracy.

In a further embodiment of the invention, the support body has a box-like housing, which is open at the rear, for the burner lance unit. The housing has the front opening and projects into the furnace interior of the electric arc furnace when the burner lance insert is inserted into the wall opening. The housing advantageously protects the burner lance unit against damage.

An electric arc furnace according to the invention has at least one burner lance insert according to the invention. The advantages of such an electric arc furnace follow from the above-mentioned advantages of a burner lance insert according to the invention.

The above-described properties, features and advantages of this invention and the manner in which they are achieved will become more clearly and explicitly understandable in conjunction with the following description of exemplary embodiments which are explained in greater detail in connection with the drawings, in which:

### BRIEF DESCRIPTION OF THE DRAWINGS

FIG. 1 is a front perspective view of an exemplary embodiment of a burner lance insert without a cover plate;

FIG. 2 is a perspective view of the burner lance insert shown in FIG. 1 in the region of a front opening;

FIG. 3 is a rear perspective view of the burner lance insert shown in FIG. 1;

FIG. 4 is a front perspective view of the burner lance insert shown in FIG. 1, a flame delivered by the burner lance insert, and a fuel delivered by the burner lance insert; and

FIG. 5 is a schematic sectional view of an electric arc furnace having the burner lance insert shown in FIG. 1.

### DESCRIPTION OF EMBODIMENTS

Mutually corresponding parts are provided with the same reference numerals in the Figures.

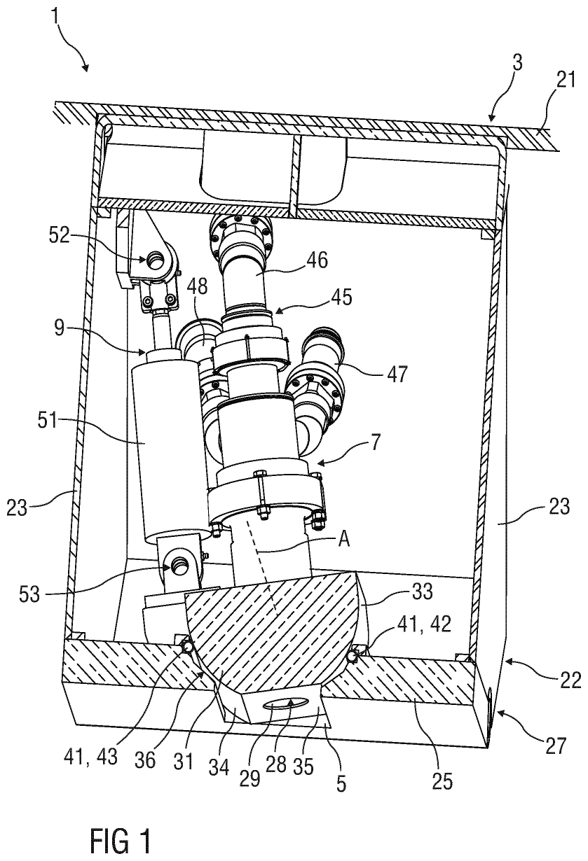

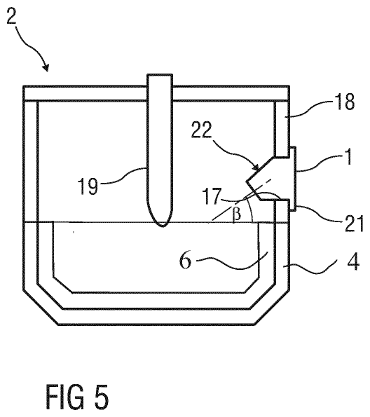

FIGS. 1 to 4 are perspective views of an exemplary embodiment of a burner lance insert 1 for an electric arc furnace 2, shown in FIG. 5. The burner lance insert 1 comprises a support body 3 having a front opening 5, a burner lance unit 7 mounted in the support body 3 to be rotatable about an axis of rotation A, and a drive unit 9 for rotating the burner lance unit 7 about the axis of rotation A.

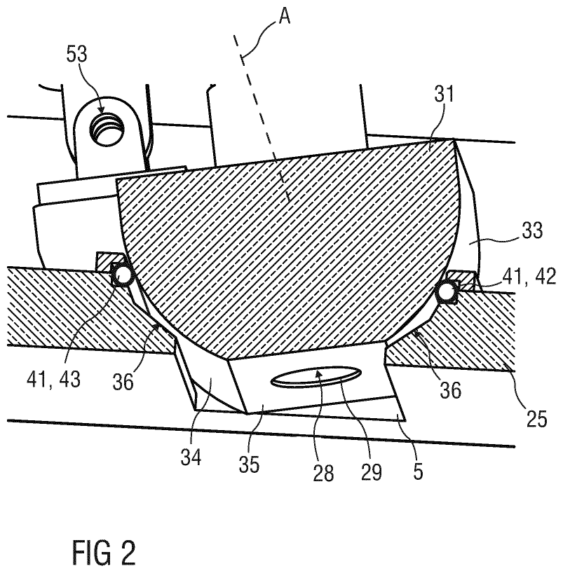

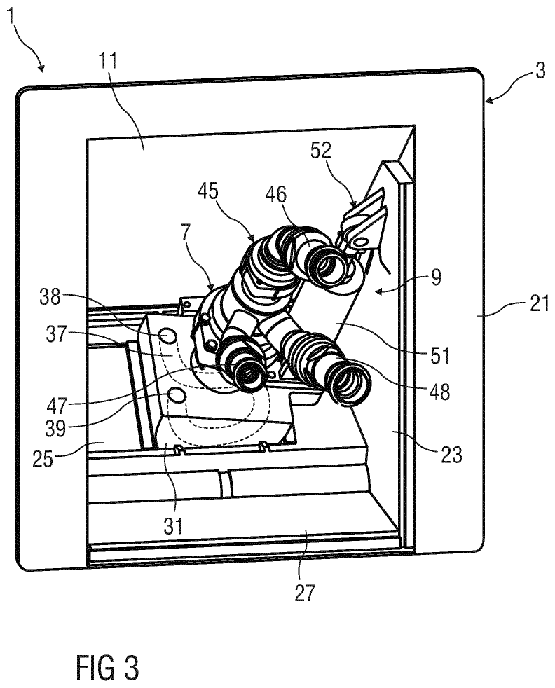

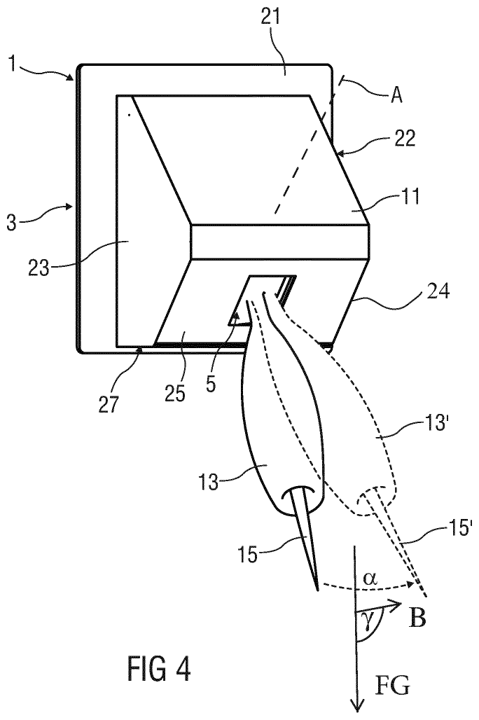

FIG. 1 shows the burner lance insert 1 from a front side without a cover plate 11 of the support body 3. FIG. 2 shows the burner lance insert 1 in the region of the front opening 5, likewise without the cover plate 11. FIG. 3 shows the burner lance insert 1 from the rear side. FIG. 4 shows the burner lance insert 1, a flame 13, 13′ delivered by the burner lance unit 7 and a fuel 15, 15′ delivered in the form of a jet by the burner lance unit 7. The fuel 15, 15′ is, for example, a gas, e.g. oxygen. In FIG. 4, the main movement component B, which is provided by the movement about the axis of rotation A, is also shown. This main movement component B is at an angle γ to the direction of the force of gravity FG. In a preferred embodiment, the angle γ is 90 degrees. Movement components can of course also point in other directions, depending on how the axis of rotation A is arranged, but the predominant part of the movement of over 60%, preferably over 70%, particularly preferably over 80%, should take place in the horizontal direction, that is at 90 degrees to the direction of the force of gravity FG.

The support body 3 can be inserted into a wall opening 17 of a furnace wall 18 of the electric arc furnace 2, so that the front opening 5 faces the furnace interior of the electric arc furnace 2. The axis of rotation is almost parallel to a front edge of the side plate 24. The side plate 23 is connected to the front plate 25, and a cover plate 11 is located above the front plate 25. The front edge of the side plate 24 is connected directly to the front plate 25.

FIG. 5 is a schematic sectional view of the electric arc furnace 2 with an electrode 19 and the burner lance insert 1 inserted into the wall opening 17. The lower portion of the electric arc furnace 2 is referred to as the furnace crucible 4. This furnace crucible has a lining 6.

The support body 3 comprises a holding frame 21 and a box-like housing 22, open at the rear, for the burner lance unit 7, from which the holding frame 21 protrudes in the manner of a flange and which projects into the furnace interior of the electric arc furnace 2 when the burner lance insert 1 is inserted into the wall opening 17. The housing 22 is formed by the cover plate 11, two side plates 23, a front plate 25 and a base plate 27. The holding frame 21 serves to secure the burner lance insert 1 to the furnace wall 18 and is configured to surround the wall opening 17. The cover plate 11, the base plate 27 and the side plates 23 each extend from the holding frame 21 to the front plate 25. The front plate 25 has the front opening 5.

The burner lance unit 7 has a delivery channel 28 which runs perpendicular to the axis of rotation A to a delivery opening located in the front opening 5 and defines a delivery direction of the burner lance unit 7 for delivery of the flame 13, 13′ and the fuel 15, 15′. In the fitted state and in a middle position which lies between two end positions, the delivery direction is at a delivery direction angle β to the upper edge of the lining 6, as is shown in FIG. 5.

The middle position is that position at which an angle of the delivery direction to a front plate, in which the delivery opening is arranged, is 90 degrees. On rotation of the burner lance unit into one of the two end positions, this angle of the delivery direction to the front plate changes. The lining 6 can also be beveled, in which case the upper edge is considered to be the imaginary edge without the bevel. The delivery direction angle β scarcely changes by a rotational movement. Thus, in the view shown in FIG. 5, there should be no pivoting movement towards or away from the electrode 19, but the pivoting movement should take place into or out of the plane.

The burner lance unit 7 has a delivery component 31 on the front opening side, through which there runs an end portion of the delivery channel 28, on the front opening side. The delivery component 31 has two convex outer surfaces 33, 34 located opposite one another on different sides of the delivery channel 28. The surface normals of the convex outer surfaces lie in planes perpendicular to the axis of rotation A and each extend to the front opening 5. The ends, on the front opening side, of the two convex outer surfaces 33, 34 are connected by a planar surface region 35 of the delivery component 31, in which the delivery opening 5 is arranged. The delivery component 31 is, for example, mounted on the cover plate 11 to be rotatable about the axis of rotation A. Two inner surfaces 36 of the front plate 25 each facing a convex outer surface 33, 34 are each beveled relative to the outer surface of the front plate 25, so that each of the two inner surfaces 36 is substantially tangential to the convex outer surface 33, 34 facing it.

The delivery component 31 has a cooling channel 37. The cooling channel 37 has a coolant inlet 38 for the introduction of a coolant into the cooling channel 37, and a coolant outlet 39 for discharging the coolant from the cooling channel 37. The cooling channel 37 runs in a U-shape around the delivery channel 28.

In the region of the front opening 5 there is arranged a seal 41 for sealing a gap between the delivery component 31 and the front plate 25. The seal 41 is formed by two sealing rolls 42, 43 which each rest against the front plate 25 and against one of the two convex outer surfaces 33, 34 of the delivery component 31. For example, the sealing rolls 42, 43 are each made of a metallic wool.

The burner lance unit 7 further has a feed unit 45 for introducing the fuel 15, 15′ into the delivery channel 28. The feed unit 45 is releasably connected to the delivery component 31 and has three feed pipes 46, 47 and 48 which extend to the rear side of the support body 3. An end, on the front plate side, of the feed unit 45 is introduced into the side of the delivery component 31 that is remote from the front plate 25.

The drive unit 9 has a drive cylinder 51 which is arranged at least approximately parallel to the delivery channel 28 and which is connected via a first link 52 to a side wall 23 of the support body 3 and via a second link 53 to the delivery component 31 of the burner lance unit 7. The drive cylinder 51 is, for example, a hydraulic or pneumatic cylinder.

By means of the drive unit 9, the burner lance unit 7 is rotatable about the axis of rotation A between two end positions. Rotation of the burner lance unit 7 from a first end position into the second end position changes the delivery direction of the burner lance unit 7 by an angle of rotation α. In the example shown in FIG. 4, the angle of rotation α is about 20 degrees. It is, however, also possible to provide a larger angle of rotation α up to 60 degrees. In a middle position of the burner lance unit 7 lying between the two end positions, the delivery direction forms an angle of between 40 degrees and 50 degrees with the direction of the force of gravity, when the burner lance insert 1 is inserted into the wall opening 17 of the electric arc furnace 2.

Although the invention has been illustrated and described in greater detail by a preferred exemplary embodiment, the invention is not limited by the disclosed example and other variations can be derived therefrom by the person skilled in the art without departing from the scope of protection of the invention. In particular, the support body 3 of the burner lance insert 1 can be configured differently than in the exemplary embodiment shown in FIGS. 1 to 5. An alternative exemplary embodiment provides, for example, that the support body 3 does not have a housing 22 which projects from the holding frame 21 into the furnace interior of the electric arc furnace 2, but that the front side of the support body 3 is substantially planar and the burner lance unit 7 is mounted in a frame of the support body 3 which is arranged on the rear side of the holding frame 21.

### LIST OF REFERENCE SIGNS

1 burner lance insert
2 electric arc furnace
3 support body
4 furnace crucible
5 front opening
6 lining
7 burner lance unit
9 drive unit
11 cover plate
13, 13′ flame
15, 15′ fuel
17 wall opening
18 furnace wall
19 electrode
21 holding frame
22 housing
23 side plates
24 front edge side plate
25 front plate
27 base plate
28 delivery channel
29 delivery opening
31 delivery component
33, 34 convex outer surface
35 planar surface region
36 inner surface
37 cooling channel
38 coolant inlet
39 coolant outlet
41 seal
42, 43 sealing roll
45 feed unit
46 to 48 feed pipe
51 drive cylinder
52, 53 link
α angle of rotation
β delivery direction angle
γ angle of main movement component to the direction of the force of gravity
A axis of rotation
FG direction of the force of gravity
B main movement component

1. A burner lance insert for an electric arc furnace, the furnace having a furnace crucible,
the burner lance insert comprising:
a support body configured to be inserted into a wall opening of the electric arc furnace;
a front opening of the support body such that after the support body has been inserted into the wall opening, the front opening of the support body faces a furnace interior of the electric arc furnace;
a burner lance unit mounted in the support body to be rotatable about an axis of rotation between two end positions;
the burner lance unit has a delivery channel which runs to a delivery opening of the burner lance unit, the delivery opening being located in the front opening of the support body;
after the support body has been inserted into the wall opening, the axis of rotation forms an angle of between 30 degrees and 60 degrees, with the direction of the force of gravity and defines a delivery direction of the burner lance unit for the delivery of a fuel and/or a flame, wherein the delivery direction is directed into the furnace crucible after the support body has been inserted into the wall opening;
the burner lance unit is comprised for performing both a burner operation and a lance operation; and
a drive unit configured for rotating the burner lance unit between the two end positions of the burner lance unit in which the delivery opening is operable to assume positions in the front opening which are different from one another and so that the delivery channel is operable to define delivery directions which are different from one another.

2. The burner lance insert as claimed in claim 1, further comprising the drive unit comprises a drive cylinder arranged at least approximately parallel to the delivery channel and is connected via a first link to the support body and via a second link to the burner lance unit.

3. The burner lance insert as claimed in claim 1, further comprising the burner lance unit comprising a delivery component on the front opening side, an end portion of the delivery channel runs through the delivery component on the front opening side of the delivery channel;
the delivery component has two convex outer surfaces located opposite one another on different sides of the delivery channel, the convex outer surfaces have surface normals which lie in planes perpendicular to the axis of rotation and which each extend to the front opening.

4. The burner lance insert as claimed in claim 3, wherein the end of the two convex outer surfaces on the front opening sides are connected by a planar surface region of the delivery component, in which the delivery opening is arranged.

5. The burner lance insert as claimed in claim 3, further comprising the delivery component has a cooling channel, a coolant inlet for the introduction of a coolant into the cooling channel, and a coolant outlet for discharging the coolant from the cooling channel.

6. The burner lance insert as claimed in claim 3, further comprising the drive unit is connected via the second link to the delivery component.

7. The burner lance insert as claimed in claim 1, further comprising a seal for sealing a gap between the burner lance unit and the support body in the region of the front opening.

8. The burner lance insert as claimed in claim 1, further comprising the burner lance unit has a feed unit for introducing the fuel into the delivery channel.

9. The burner lance insert as claimed in claim 8, wherein the feed unit is releasably connected to the delivery component.

10. The burner lance insert as claimed in claim 1, further comprising the delivery channel runs perpendicular to the axis of rotation.

11. The burner lance insert as claimed in claim 1, further comprising the delivery direction in a middle position of the burner lance unit lies between the two end positions and forms an angle of between 30 degrees and 60 degrees with the direction of the force of gravity, when the burner lance insert is inserted into the wall opening of the electric arc furnace.

12. The burner lance insert as claimed in claim 1, further comprising the support body has a front plate in which the front opening is arranged, a cover plate arranged above the front plate, and two side plates, wherein the side plates are each connected to the front plate and to the cover plate and enclose the front opening;
the axis of rotation is configured so that the burner lance unit is rotatable predominantly in the direction of one of the two side plates.

13. The burner lance insert as claimed in claim 1, wherein a rotation of the burner lance unit from a first one of the end positions into a second one of the end positions changes the delivery direction by up to 60 degrees.

14. The burner lance insert as claimed in claim 1, wherein a rotation of the burner lance unit from the first one of the end positions into the second one of the end positions changes the delivery direction by from 20 to 30 degrees.

15. The burner lance insert as claimed in claim 2, further comprising the drive cylinder is a hydraulic or pneumatic cylinder.

16. An electric arc furnace comprising at least one burner lance insert formed according to claim 1.
